(19) United States
(12) Patent Application Publication
(10) Pub. No.: US 2008/0243564 A1
(43) Pub. Date: Oct. 2, 2008

(54) TRAVEL PLAN GENERATION

(75) Inventors: Carsten Busch, Weinheim (DE); Veronica Toumanova, Karlsruhe (DE); Volker Mueller, Karlsruhe (DE); Ramin Bagheri, Schwetzingen (DE); Sylke Sattler, Roemerberg (DE); Ingrid Reiss, Hirschberg (DE); Daniel Beringer, New York, NY (US)

Correspondence Address: FISH & RICHARDSON, P.C., PO BOX 1022, MINNEAPOLIS, MN, 55440-1022, US

(73) Assignee: SAP AG

(21) Appl. No.: 11/694,834

(22) Filed: Mar. 30, 2007

(51) Int. Cl. G01C 21/34

(52) U.S. Cl. 705/6

(57) ABSTRACT

In a computing system, an identification of a traveler, a destination, a departure date, and one or more activity indicators is received from a user. One or more predefined tasks to be executed in preparation for travel by the traveler based on the received information are generated. Each of the one or more received activity indicators is used to generate a task. A travel plan that includes the one or more tasks to be executed is displayed.

### TECHNICAL FIELD

This disclosure relates to generating a travel plan.

### BACKGROUND

Arranging business travel today can involve researching, planning, and selecting from among a myriad of choices, which can often take a significant amount of time. Although travel itineraries can vary in complexity, even the simplest travel arrangements generally involve selection of at least a destination, a time period, accommodations and transportation (to and from). Frequently, several options exist for one or more of the categories. For this reason, business travelers often rely on an administrative assistant to schedule and coordinate travel plan details so that the traveler may focus on business responsibilities.

For some administrative assistants, travel planning and coordination can occupy a significant part of their work day, especially when they have travel detail responsibilities for more than one executive, manager or employee who frequently travels for business. Of course, even after travel plans have been made, they are subject to change. Meetings may be canceled, moved or rescheduled, and flights can be delayed. Additionally, the traveler's preferences or wishes may change as the departure date approaches or even during the travel period, which can require that the assistant make last minute or on-the-fly changes to the travel plan.

Assistants often use phone, fax, or e-mail in researching and booking travel plan arrangements. Various applications or systems may be used, including flight booking systems (e.g., an airline's online reservation system or a travel agency booking system), hotel booking systems (e.g., a hotel's online system or a travel agency booking system), and calendar applications. Throughout, the assistant may keep electronic records of some of the details, paper records of other of the details, and both paper and electronic copies of some of the details. However, in addition to occupying a significant portion of the assistant's time, this use of multiple systems and multiple methods of tracking may add to the complexity of the travel planning, which may cause the assistant to inadvertently overlook or miss certain travel plan aspects, which may result in an unsatisfying travel experience for the traveler.

### SUMMARY

This disclosure relates to generating a travel plan.

In a first general aspect, a method includes receiving an identification of a traveler, a destination, a departure date, and one or more activity indicators from a user. The method also includes generating one or more predefined tasks to be executed in preparation for travel by the traveler based on the received information. Each of the one or more received activity indicators is used to generate a task. The method further includes displaying a travel plan that includes the one or more tasks to be executed.

In selected embodiments, each of the one or more tasks may include a status indicator that describes a level of completion for the task. The one or more activity indicators may be travel options. Generating a predefined task may include identifying a predefined task that is associated with the received activity indicator. Each of the one or more tasks may be associated with an action to be performed, and the action associated with the task may be performed. The one or more predefined tasks may be selected from the group consisting of flight booking, hotel booking, rental car booking, and passport. The travel plan may include a graphical representation of the travel plan, and the graphical representation may include an icon for each of one or more destinations in the travel plan, and one or more line segments that connect icons. Each of the one or more received activity indicators may be used to generate a distinct task. The one or more tasks to be executed may be exported to an external program application to be presented in the external program application.

In a second general aspect, a computer program product tangibly embodied in an information carrier includes instructions that when executed by a processor perform a method to receive an identification of a traveler, a destination, a departure date, and one or more activity indicators from a user. One or more predefined tasks to be executed in preparation for travel by the traveler based on the received information are generated, and each of the one or more received activity indicators is used to generate a task. A travel plan that includes the one or more tasks to be executed is displayed.

In a third general aspect, a method includes receiving an identification of a traveler, a destination, a departure date, and one or more activity indicators from a user. The method also includes generating one or more predefined tasks to be executed in preparation for travel by the traveler based on the received information. Each of the one or more received activity indicators is used to generate a task. The method further includes displaying a travel plan that includes the one or more tasks to be executed, and connecting, in response to a user selection of one of the displayed tasks, to an external computing system to execute the task.

Advantages of the systems and techniques described herein may include any or all of the following: complexity in managing travel experiences for one or more travelers may be reduced; travel plans may be managed from a central location; travel may be more easily coordinated among multiple travelers; record keeping efficiency may be improved; travel experiences for travelers may be improved; docketing tasks to be executed may be more robust and more effective; and assistants responsible for travel detail planning may be better able to manage their duties.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary architecture that can be used to create a travel plan.

FIGS. 2-3 are screen shots of exemplary user interfaces that can be used for receiving travel-related input.

FIG. 4 is a screen shot of an exemplary user interface that can be used for defining or presenting a travel itinerary.

FIG. 5 is a screen shot of an exemplary user interface that can be used for presenting tasks associated with a travel itinerary.

FIG. 6 is a screen shot of an exemplary user interface that can be used for performing an action associated with a task.

FIG. 7 is a screen shot of an exemplary user interface that can be used for including task information with a travel itinerary.

FIG. 8 is a screen shot of an exemplary user interface that can be used for receiving travel-related feedback.

FIG. 9 is a flow chart of exemplary operations that can be performed to create a travel plan.

FIG. 10 is a schematic diagram of a computing system that can be used in connection with computer-implemented methods described in this document.

Like reference symbols in the various drawings indicate like elements.

### DETAILED DESCRIPTION

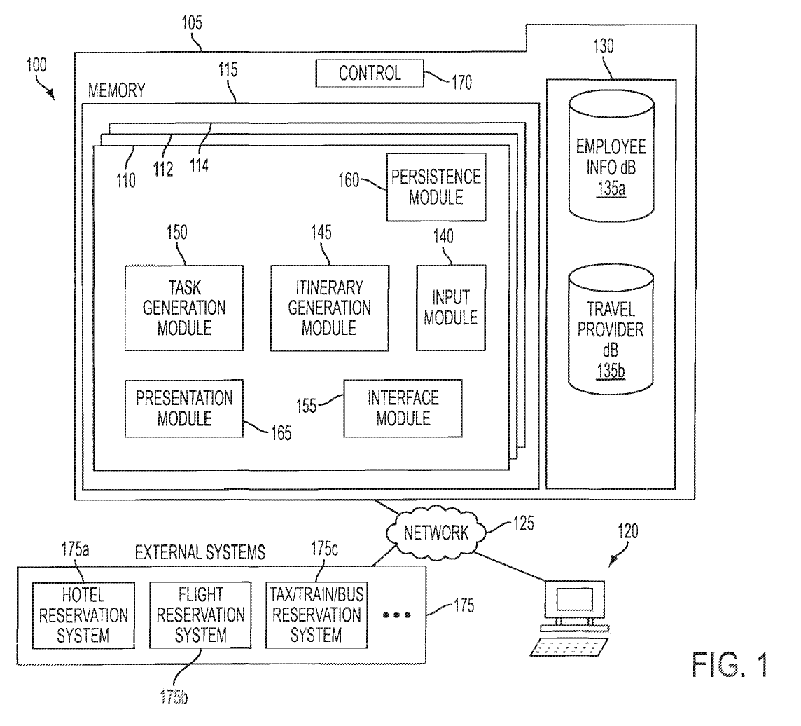

FIG. 1 is a block diagram of an exemplary architecture 100 that can be used to create a travel plan. Using the architecture 100 shown in FIG. 1, a user, such as an administrative assistant, may enter information pertaining to one or more upcoming travel experiences for one or more travelers, and the architecture 100 may generate a travel plan, according to an implementation. In an implementation, the travel plan may include one or more tasks. The one or more tasks may indicate actions to be taken in preparation for the traveler's travel, according to an implementation. Tasks can include a status indicator that indicates a level of completion for the task. The status indicator may be changed to reflect whether the task remains to be executed, is in the process of being executed, or has been completed, to list just a few examples. In some implementations, tasks can include a reminder that may be presented to remind the user that the action should be taken. Some tasks may pertain to a single traveler, and some tasks may pertain to multiple travelers. In various implementations, some or all of the tasks may be performed by the user (the administrative assistant in this example), the traveler, the architecture 100, or some combination of the above. The tasks may provide a convenient reminder of actions that should be taken in advance of the travel, as the travel date approaches, or perhaps during the travel. In this fashion, travel details may be tracked, monitored, stored, and referenced, such that preparations for the travel may be completed in an efficient and organized manner. This may result in a more enjoyable travel experience for the traveler, and may ease the burden of the user in planning for the travel experience.

In general, a user may enter travel details such as an identity of a traveler, a travel destination, and a departure date. The user may also, in some implementations, enter or select one or more activity indicators that may describe options or activities associated with the upcoming travel experience. In an implementation, the activity indicator may indicate an activity for which an action should be taken or performed prior to the occurrence, use or enjoyment of the activity or of the travel experience. The activities may typically be associated with the travel experience or with a portion of the travel experience, according to some implementations. Activity indicators can relate to any aspect of the travel experience, including transportation options for the travel, accommodation options for the travel, appointment options for the travel, clearance or admissibility options for the travel, service options for the travel, communications or accessibility options for the travel, coordination details of the travel, and the like. The system may use the entered information to automatically generate one or more tasks, according to an implementation. In some implementations, the tasks may be generated in response to the receipt of the activity indicators, and may correspond to actions that should be taken or performed prior to the occurrence, use, or enjoyment of the associated activity or of the travel experience.

Referring again to FIG. 1, an exemplary architecture 100 that may be used to generate a travel plan is shown. In general, a user may enter travel details into a graphical user interface on a server device 105 included in the architecture 100. In an implementation, the architecture 100 includes various applications, such as a travel application program 110, a scheduling application 112 and a calendar application 114, that are generically shown residing in memory 115 on the server device 105. The architecture 100 may use the travel application program 110 to generate a travel plan for presentation on one or more client devices 120 over a network 125. In generating the travel plan, the travel application program 110 may access stored electronic information from electronic data storage 130. The electronic data storage 130 may include one or more data repositories 135, on which various electronic databases of information may be stored and maintained. In some implementations, the one or more data repositories 135 may be included in the server device 105, as shown in FIG. 1, but in other implementations some or all of the data repositories 135 may be external to the server device 105, and may be communicably coupled to the server device 105 for data access.

In general, travel plans may be modified or updated by the architecture or by the user during the preparation stages for the travel experience, during the travel experience, or after the travel experience, according to an implementation. For instance, as actions are completed to satisfy tasks in preparation for the travel, the travel plan may be updated to reflect the change. If circumstances, such as a flight delay or a rescheduling of an appointment, for example, dictate a change in the plan during the travel, the travel plan may be suitably adjusted. Following completion of the travel, feedback may be entered to describe or rate aspects of the travel for future reference, costs may be entered or updated, expense reports may be generated, and rewards programs (e.g., frequent flyer miles, credit card rebate points, etc.) may be tracked or updated, to list just a few examples.

Travel plans can be as complex or as simple as desired, which can provide flexibility in managing the travel experiences. Some administrative assistants may have travel detail responsibilities for only one person, while other assistants may have travel detail responsibilities for two, three, four, ten, twenty or more persons, each of whom may have particular preferences, wishes, schedules and the like. For example, a company may send a team of employees to a sales meeting or a trade conference in another city. The employees may choose to take different flights, trains, or other methods of transportation, may choose different departure and/or return dates, and may decide to stay at the same or different hotels. Some employees may even arrive at the sales meeting or trade conference from a previous travel destination, or may depart from the sales meeting or trade conference for a subsequent additional travel destination. Taxis or shuttles may be needed for some of the employees, while others may choose to rent a vehicle. Some employees may return home earlier than others, some may stay for the duration of the event, and others may extend their stay longer. Similarly, in some cases a traveler may travel to a single destination and return after a period of time. In other cases, the traveler may depart to a first destination, stay for a period of time and depart from the first destination to a second destination, stay for a period of time and then depart for a third destination, etc., and finally return home. Using the systems and methods described herein, one or more travel plans may be created to manage all of the complexity described above, for example.

In an implementation, the travel application program 110 includes various modules, including an input module 140, an itinerary generation module 145, a task generation module 150, an interface module 155, a persistence module 160 and a presentation module 165. The modules shown in the architecture 100 are exemplary and may be combined or separated in any desired fashion, including residing or operating on more than one computing device. For example, portions or all of the travel application program 110 may execute on the client device 120 or on another server device (not shown) in some implementations. In some implementations, additional modules may be included, and in other implementations one or more of the pictured modules may be omitted.

The input module 140 may receive input to be used in generating, updating, or maintaining a travel plan. Inputs can be received from a user entering input in a user interface, such as a graphical user interface or a voice-activated user interface, or from another application program running on the server 105 or on another computing device, including input from one or more external systems in communication with the server device 105. Examples of inputs that may be received include, without limitation, an identification of a traveler, a travel start date, a travel end date, a time indicator (e.g., a flight departure time), a destination, such as an indication of a city, a place of business (e.g., company's Japanese sales office), an airport or the like, an activity indicator, a cost, an estimate, an appointment, preparation materials, travel-related recommendations, travel-related feedback or ratings, and travel requirements, among others.

The itinerary generation module 145 may use the received input to generate an itinerary for the travel plan. Itineraries may be generated for a single traveler or for multiple travelers, according to an implementation. In an implementation, the itinerary includes an indication of each stop or destination of the travel experience in the order of occurrence of each stop or destination, starting from the original home location, through intermediate destinations, if any, and concluding with the final destination. In an implementation, the system may initially assume that the final destination is the same as the original home location, which may relieve the user of entering a final destination. If the final destination should be different from the home location, the user may specify an alternative final destination.

In some implementations, the system may generate and present a graphical representation of the itinerary. For example, the itinerary may be displayed on a display of the client device 120, emailed or otherwise transmitted to an account (e.g., the traveler's or another's email account), stored to a memory location, or exported to one or more other applications, to list just a few examples. The itinerary may include start and stop dates associated with each destination in the itinerary, according to an implementation. The graphical representation of the itinerary may provide a convenient and quick summary of the travel experience, and may be useful for comparing travel plans of more than one traveler, for instance. In this fashion, for example, the user or the architecture may quickly determine where travel schedules overlap, and may be able to reduce costs by combining aspects of the travel, to list just one example. Travelers, as well, may be better able to coordinate their travel plans.

The itinerary generation module 145 may use a rule-based engine to generate the itinerary, according to an implementation. In an implementation, the module 145 may sort the dates associated with each of the destinations in the travel plan chronologically. Error checking may be done, including identifying when the sorted dates and destinations fail to indicate a contiguous sequence of destinations and destination periods (that is, periods of time to be spent at a particular destination, defined by the destination's start date and stop date, for example). In some cases, a non-contiguous sequence may be acceptable, such as when details of a particular period within the travel experience are not yet known but may be determined later. At that time, the travel plan can be updated with the new information and the itinerary can be updated.

The task generation module 150 may use received input to generate one or more tasks for the travel plan. Tasks can be associated with one or more particular destinations in a travel plan or for the travel plan in general (that is, generally applicable and not particular to a single destination or subset of destinations). Like itineraries, tasks can apply to a single traveler or to multiple travelers. Tasks may indicate an action to be performed in planning, arranging, preparing for, scheduling, or modifying a travel experience. In some cases, these tasks may remind the user of actions that should be performed so that the travel experience may be as successful and enjoyable for the traveler as possible. In an implementation, a task may be related to an activity indicator entered by a user. The system may receive a user-entered activity indicator and may use one or more predefined rules to determine if a task should be generated based on the received activity indicator, and if so may generate a predefined task associated with the activity indicator, according to an implementation. In some implementations, the architecture may generate one or more tasks for each received activity indicator. In other implementations, the architecture may not generate a separate task for each received activity indicator. In some implementations, a task may be associated with more than one received activity indicator.

Tasks can include a description of the action that should be performed. In some implementations, a task can include a control that may be used to perform a portion or all of the task, according to an implementation. For example, a task may include a hyperlink that the user may select to be connected to an internal or external computing system, such as a reservation system, an application system or a confirmation system, to list just a few examples, on which they may perform the task (e.g., book a flight reservation or hotel reservation, reserve a rental car, schedule a meeting, schedule a vaccination, order clearance documents, confirm a reservation, request a cash or currency allowance, etc.). In some implementations, the task may include a status indicator that may indicate a level of completion of the task. Some tasks may have one or more associated deadlines, and the system may present reminders as the one or more deadlines approach, according to some implementations.

The interface module 155 may be used to communicate with other application programs, including application programs executing on the server device 105 or application programs executing on other computing devices. The travel application program 110 may use information received through the interface module 155 to generate the travel plan, according to an implementation. For example, appointment information may be imported from a scheduling program 112 or calendar program 114, such as Microsoft Outlook, and may be used in creating a travel plan, according to some implementations. In some implementations, the interface module 155 may communicate with external systems such as external reservation systems for booking or confirming flights, hotel reservations, taxi, train, limousine or shuttle service, dinner reservations, ticket orders, or any other arrangement that the system may make as part of the travel plan generation or follow-up task execution. In some implementations, tasks that the system generates in producing a travel plan may be exported, using the interface module 155, to another program application for presentation in that program application. In this fashion, the user may be reminded that the tasks should be executed by viewing the tasks in an environment outside of the travel planning application. This may provide an additional layer of assurance that the tasks will not be inadvertently missed. The tasks may be exported in a common interface format or programming framework, for example, such that they may integrate with other programs, or may be exported in a format specific to the external application. In various implementations, one or more of the scheduling program 112 or the calendar program 114 may reside and execute on another computing device, such as client device 120 or an external computing system communicably connected to the network 125 for communication with the server device 105. In some implementations, the scheduling and calendar applications 112, 114 may be merged or omitted.

The persistence module 160 may be used to access electronic data information stored in the electronic data storage 130. The persistence module may retrieve information from a data repository 135 and may store information to a data repository 135, according to an implementation. In some implementations, the persistence module 160 may include search functionality for generating a query to search one or more data repositories 135 for information stored in a database on the one or more repositories 135. The presentation module 165 may render views for presentation on a display device, such as an LCD or CRT monitor. Views may be presented, for example, on a display of the server device 105 or client device 120, according to an implementation. In an implementation, views of a travel plan may be presented. In some implementations, travel plan views may be presented in a separate application, such as a word processing application, scheduling application, calendar application, web browser, or other system application.

The architecture 100 includes or is communicably coupled with the server 105, the one or more client systems 120, and control devices 170, at least some of which can communicate across the network 125. The server 105 generally hosts application software for receiving user input to generate a travel plan. The server 105 comprises an electronic computing device operable to receive, transmit, process and store data associated with the architecture 100. Although FIG. 1 illustrates a single server 105 that may be used with the disclosure, the architecture 100 may be implemented using one or more computers other than servers, as well as a server pool. The server 105 may be any computer or processing device, such as, a blade server, general-purpose personal computer (PC), Macintosh, workstation, Unix-based computer, or any other suitable device. According to one implementation, the server 105 may also include or be communicably coupled with a web server and/or a mail server.

In the exemplary implementation shown in FIG. 1, the electronic data storage 130 includes an employee information database and a travel provider database, each shown illustratively as a data repository 135a and 135b, respectively. The employee database 135a may store employee information, such as names, addresses, titles, responsibilities, contact information, team information, division information and the like. The travel provider database 135b may store information pertaining to various travel providers, including airline information, hotel information, ground transportation provider information, service organization information, etc., and may include information on systems that may be used to book reservations with the travel providers. For example, email addresses, telephone numbers, fax numbers, URL information, etc., may be stored for use by the travel application program 110. The interface module 155 may then use this information to connect and interact with other systems (e.g., systems 175).

The one or more data repositories 135 may include any memory or database module and may take the form of volatile or non-volatile memory including, without limitation, magnetic media, optical media, random access memory (RAM), read-only memory (ROM), removable media, or any other suitable local or remote memory component. Additional information that may be stored in the electronic data storage 130 may include travel plans, itineraries, task information, search results, virtual private network (VPN) applications or services, firewall policies, a security or access log, print or other reporting files, HTML files or templates, data classes or object interfaces, unillustrated software applications or sub-systems, and others.

The server device 105 also includes control devices 170. The control devices 170 may include one or more processors to execute instructions and manipulate data for performing the operations of the server 105. The control devices 170 may include, for example, a central processing unit (CPU), a blade, an application specific integrated circuit (ASIC), a field-programmable gate array (FPGA), or other suitable hardware or software control system. In the illustrated implementation, the control devices 170 execute instructions that comprise the application 110.

The network 125 may facilitate wireless or wireline communication between the server 105 and any other local or remote computers, such as client 120 or external systems 175. The network 125 may be all or a portion of an enterprise or secured network. In another example, the network 125 may be a VPN between the server 105 and the client 120 across a wireline or a wireless link. While illustrated as a single or continuous network, the network 125 may be logically divided into various sub-nets or virtual networks without departing from the scope of this disclosure, so long as at least a portion of the network 125 may facilitate communications between the server 105 and at least one client (e.g., client 120) or external system 175. In certain implementations, the network 125 may be a secure network associated with the enterprise and certain local or remote clients 120. The network 125 may be the Internet, or a portion thereof The client 120 may be any computing device operable to connect or communicate with the server 105 or the network 125 using any communication link. At a high level, each client 120 may include or execute at least one hosted application graphical user interface. There may be any number of clients 120 communicably coupled to the server 105. As used in this disclosure, the client 120 is intended to encompass a personal computer, touch screen terminal, workstation, network computer, kiosk, wireless data port, smart phone, PDA, one or more processors within these or other devices, or any other suitable processing device. For example, the client 120 may be a PDA operable to wirelessly connect with an external or unsecured network.

The external systems 175 may include remote computer systems that may communicate with the server 105 or client 120 over the network 125. Any number of external systems may be used, and the exemplary implementation shown in FIG. 1 includes a hotel reservation system 175a, a flight reservation system 175b, and a taxi or train or bus reservation system 175c. In general, the travel application program 110 may use the interface module 155 to contact any system that can schedule or confirm travel details, according to an implementation. In some implementations, one or more external systems 175 may be accessed during generation of a travel plan. In other implementations, one or more external systems 175 may be accessed during generation or an itinerary or task, or in performing an action associated with a task, for example. Some of the systems 175 may be dedicated to a particular business (such as a hotel's or airline's reservation system), and other of the systems 175 may be serve multiple businesses (e.g., a general reservation system such as Expedia, Orbitz, Travelocity, and the like). In an implementation, a user using the travel application program 110 may select a connection (e.g., a URL associated with an external system 175 and stored in repository 135b) to an external system 175 and be connected to the external system 175, and may make a reservation for the traveler. In some implementations, the architecture 100 may automatically pass information between the system and an external system 175, for example to expedite reservation creation.

The following exemplary descriptions of screen shots focus on the operation of the travel application program 110, or one or more of its components or sub-modules, in performing one of the exemplary methods or processes. However, the architecture 100 can use any appropriate combination and arrangement of logical elements implementing some or all of the described functionality. The examples that follow will illustrate how an administrative assistant may use the travel application program 110 to create a travel plan for an employee for which the assistant has travel detail responsibilities. For simplicity, the example screen shots will illustrate the creation of a travel plan for a single traveler traveling to a destination and returning home, but travel plans including multiple destinations, multiple travelers, or multiple travelers with multiple destinations may be created.

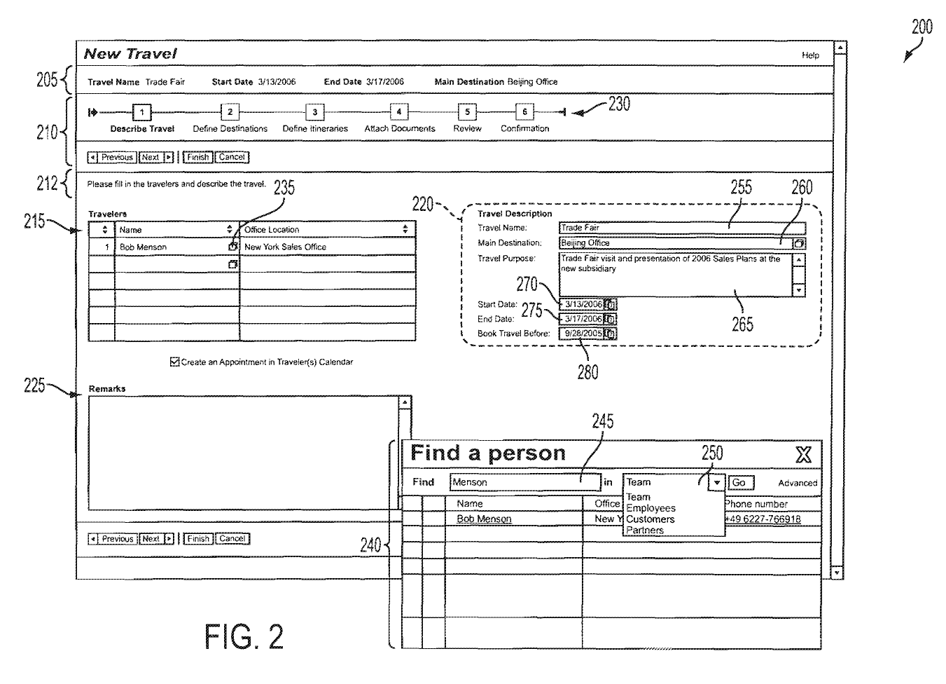

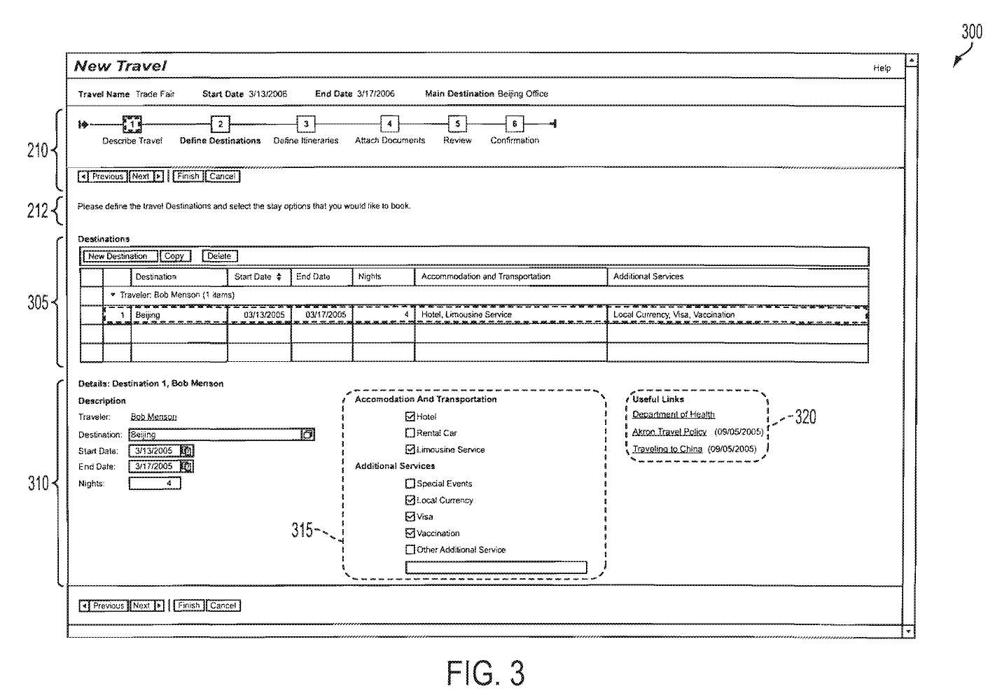

FIGS. 2-3 are screen shots of exemplary user interfaces 200, 300 that can be used for receiving travel-related input. Referring first to FIG. 2, user interface 200 includes several panes of content, including a label area 205, a wizard area 210, an instruction area 212, a traveler identification area 215, a travel description area 220, and a remarks area 225. The label area 205 may be used to provide basic or high-level information about a travel experience, according to an implementation. In the example interface 200 shown in FIG. 2, label area 205 includes a travel name, start and end dates, and a main destination. The wizard area 210 may provide a representation of a step-by-step process by which a user may use the system to generate a travel plan. A first step, labeled “Describe Travel,” is shown highlighted in the wizard area 210, and may indicate that a user may use the interface 200 to define aspects of the travel experience. The system may update the wizard area 210 as the travel plan is generated, as by highlighting or 10 otherwise indicating partial or full completion of steps in the process. This may provide the user with a concise visual indication of the step that is currently being performed, as well as steps that have been completed and steps that remain to be completed. Selectable controls within the wizard area 210 may permit the user to move among steps of the process. The instruction area 212 may be used to provide instructions or information that may assist the user in using the system.

The traveler identification area 215 may receive input that identifies one or more travelers that will be traveling as part of the travel experience. A user may enter the name or identification of one or more travelers in any of several ways, including by typing a name into a field of the area 215 or by selecting an identifier that indicates the traveler. For example, in an implementation, the user may select an icon 235, and the system may provide a traveler search area 240, which the user may use to identify a traveler for inclusion in the traveler identification area 215. In various implementations, the traveler search area 240 may be provided as a pop-up window or as an integrated panel in the interface 200, and may include a field 245 where a search term may be entered and a control 250 that may be used to further define the search. In the example shown in FIG. 2, the user has entered “Menson” in the search field 245 and has selected “Team” from the control 250. As such, the system may identify all team members having “Menson” as part of their name, for example by searching the employee information database 175a (see FIG. 1). In the example, the search results show “Bob Menson” and some related information, and the user may select a search result for inclusion in the traveler identification area 215, as shown in the example of FIG. 1. The user could additionally search for other team members, employees, customers or partners, for example. In some implementations, identifiers may be presented in a drop-down list, and the user may select a traveler from the list. In yet other implementations, identifiers may be presented as an integrated panel in the interface 200, or in any other suitable presentation scheme.

The travel description area 220, in this example, includes fields for naming the travel experience (255), specifying a primary destination (260), specifying a travel purpose (265), defining a travel start date (270) and end date (275), and specifying a date by which travel should be booked (280). As shown in the travel description area 220 of the interface 200, the user has named the travel experience “Trade Fair,” has denoted “Beijing Office” as the main or primary destination, and has selected 3/13/2006 and 3/17/2006 as the start and end dates, respectively, for the travel. The system has summarized this information by displaying it in the label area 205, as described above. In this example, Bob Menson will be traveling from the New York Sales Office to the Beijing Office to visit a trade fair and present sales plans, as described in the travel purpose area 265. The remarks area 225 may be used to enter remarks pertaining to the travel experience.

Referring next to FIG. 3, exemplary interface 300 permits a user to define travel destinations and select options associated with a destination, as described by the text shown in the instruction area 212. The wizard area 210 shows that the program has progressed to step two of the process. Interface 300 may be presented, for example, following a user selection of the “Next” control in the wizard area 210 of interface 200 (FIG. 2).

A destinations area 305 and a details area 310 permit a user to provide additional input on the travel experience to the travel application program 110 by entering additional information in the interface 300. The system may use this information to generate a travel plan, according to an implementation. The user may specify one or more destinations in the destination area 305. In this example, a single destination (Beijing) is shown for a single traveler (Bob Menson), corresponding to the information entered in interface 200 (FIG. 2). The user could select a “New Destination” control to add a second destination, for example. In an implementation, a user may use interface 300 to define travel destinations for each traveler specified in the previous interface 200 (see FIG. 2).

The details area 310, in this implementation, includes an activity indicator section 315 that includes one or more selectable activity indicators. In an implementation, the activity indicators may be provided under representative headings, such as the “Accommodation and Transportation” and “Additional Services” headings shown in FIG. 3. Each activity indicator may describe an option or activity related to the travel destination, according to an implementation. By selecting an activity indicator, the user may indicate that the selected option is appropriate for the travel experience. In this example, the user has selected the “hotel,” limousine service,” “local currency,” “visa,” and “vaccination” activity indicators. This may indicate that a hotel reservation should be booked, a limousine should be rented or reserved, currency conversion may need to be performed, a visa may need to be obtained or updated, and a vaccination may be appropriate.

Activity indicators may be predefined by the system, according to an implementation. In some implementations, associations between activity indicators and destinations may be predetermined, and associated activity indicators may be presented for selection in interface 300 when the associated destination has been specified. For example, each time a foreign destination is specified, the system may present a “passport” activity indicator that may be selected by the user, or may be pre-selected by the system in certain implementations. In other implementations, associations between activity indicators and travelers may be predetermined, and associated activity indicators may be presented for selection in interface 300 when the associated traveler has been specified. In yet other implementations, associations between activity indicators and other factors, such as time of the year (e.g., winter season, summer season, busy travel season, vacation season), calendar dates (e.g., holidays), businesses or business relationships (e.g., parties with whom the traveler will meet during the travel experience, relationships among such parties to other clients or competitors, etc.), schedules (e.g., deadlines, appointments, meetings) and the like may be predetermined and presented for selection in the interface 300 as appropriate. In some implementations, a rules-based engine may be used to identify predetermined activity indicators that should be presented for selection in the interface 300 for a given travel experience.

Activity indicators may indicate any activity, action or service associated with travel, business, personal preferences, a country or region, a travel provider, a travel service, and the like. In this example, the rental car, special events, and other additional service indicators were not selected. In other examples, more or fewer activity indicators may be presented, and the user may select any of the presented indicators. Activity indicators can be as general or as specific as desired. Examples of additional activity indicator categories that may be presented include, without limitation, hotel preferences (e.g., non-smoking, suite, king-size bed, late check-in, restaurant options, etc.), transportation options (e.g., shuttle service, train, bus, recreational vehicle), region-specific indicators (e.g., customs, languages, preferences, traditions, etc.), business-specific indicators (e.g., contact persons and preferences, responsibilities, meeting rooms, access codes, visitor passes, etc.), among others. The forgoing list is intended to illustrate examples of activity indicators that may be presented, but many other activity indicators are possible. In general, any action, activity, service, reminder, recommendation, tip or precaution related to the travel experience may be presented as an activity indicator for selection by the user, according to some implementations. The system may store the activity indicators in the electronic data storage 130, according to an implementation. As will be described in more detail below, the system may use the received information, including the selected activity indicators, in preparing tasks and itineraries for the travel plan.

An additional information area 320 includes links to additional information that may be relevant to the travel plan, such as by relating to the destination or to one or more of the activity indicators 315. The user may select a hyperlink and the system may use the link to present an appropriate view to the user. The links to additional information may be stored in the electronic data storage 130.

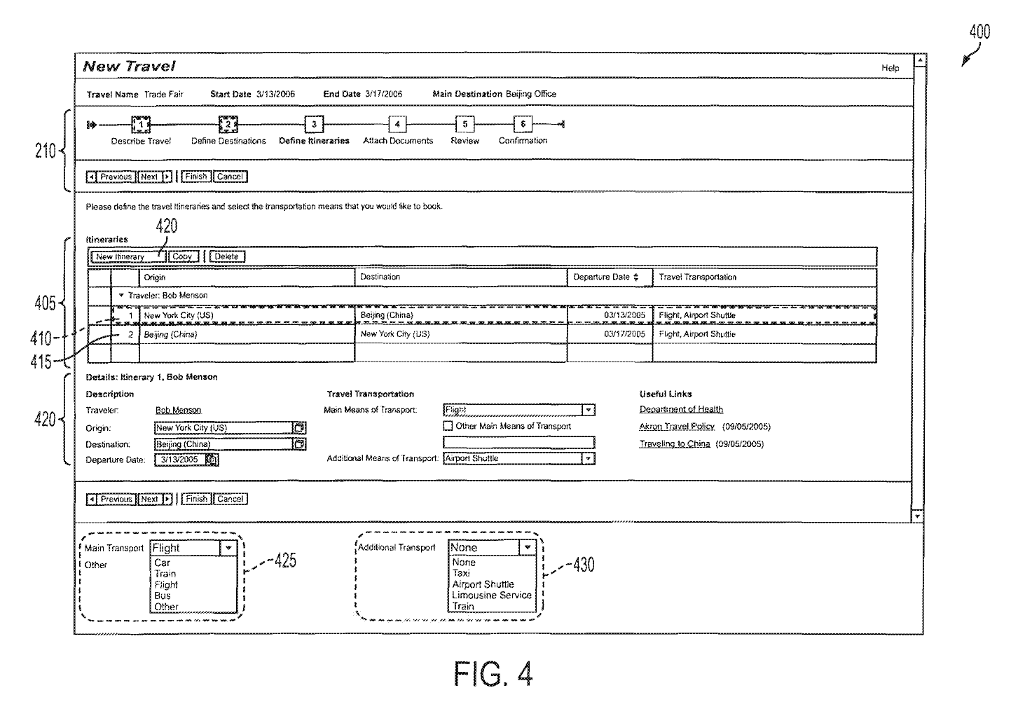

FIG. 4 is a screen shot of an exemplary user interface 400 that can be used for defining or presenting a travel itinerary. The wizard area 210 shows that the program has progressed to step three of the process. An itineraries area 405 may be used to present one or more itineraries for a travel plan. In some implementations, an itinerary may indicate a portion of the travel experience defined from a first destination to a second destination, and may include options or selections associated with this portion of the travel experience. In other implementations, an itinerary may indicate a portion of the travel experience defined from a first destination to a second destination and back to the first destination, and may include options or selections associated with this portion of the travel experience. In yet other implementations, an itinerary may be associated with all stops or destinations in a travel experience. In various implementations, an itinerary may be associated with one traveler or multiple travelers. A travel plan can include any number of itineraries, according to an implementation, such as one, two, three, four, five, six, etc.

In the example interface 400 shown in FIG. 4, two itineraries are shown in the itinerary area 405. Both itineraries are for traveler Bob Menson, as indicated by the label “Traveler: Bob Menson” in the area 405. The first itinerary 410, shown highlighted in the interface 400, includes “New York City” as an origin, “Beijing” as a destination, March 13 as a departure date, and flight and airport shuttle transportation options. The second itinerary 415, corresponding to the return portion of the travel experience, includes “Beijing” as an origin, “New York City” as a destination, March 17 as a departure date, and flight and airport shuttle transportation options. A user may create a new itinerary by selecting a “New Itinerary” control 420, according to an implementation. The new itinerary could correspond to a new destination for the travel experience, according to an implementation. For example, a new destination of Paris could be indicated, and the user could specify options appropriate for this portion of the travel experience.

In some implementations, the system may automatically modify one or more existing itineraries when the user adds a new itinerary or destination. For example, if the user defines a new itinerary with Beijing as the origin, Paris as the destination, and a departure date of March 15, the system may automatically update the second existing itinerary 415 to specify Paris as the origin, rather than Beijing, according to an implementation, noting that the itinerary 415 as previously defined is inconsistent with the newly added itinerary or destination. In some cases, the system may ask the user for permission to make the changes or to confirm that the requested addition is indeed intended.

In an implementation, the system may automatically create two itineraries when a first destination is entered, according to an implementation. The first itinerary may be created with a home location as the origin and the first destination as the destination. The second itinerary may be created with the entered destination as the origin and the home location as the destination, representing a return trip. Similarly, according to an implementation, if a user creates a first itinerary by specifying an origin and a destination, the system may automatically create a second itinerary having as an origin the destination of the first itinerary and having as a destination the origin of the first itinerary.

An itinerary details area 420 may be used to enter or modify travel itinerary information. When information is entered or modified in the details area 420, the system may correspondingly update the itinerary area 405 as appropriate, according to an implementation. The itinerary details area 420 in the interface 400 provides details for the first itinerary, corresponding to the highlighted itinerary 410 in the itinerary area 405. The user could select the second itinerary 415, for example, and the system may update the details area 420 to present details of the second itinerary 415.

In the exemplary details area 420 of FIG. 2, origin, destination and departure date may be entered or modified, and various transportation options may be selected. In this example, the user has selected “flight” as a main means of transport, which may indicate that the traveler plans to fly from New York to Beijing. Additionally, the user has selected “airport shuttle” as an additional means of transport. The transportation options in this example may be selected using drop-down list box controls. Exemplary drop-down list box choice groups 425, 430 are shown illustratively below the interface 400. A main transport group 425 includes car, train, flight, bus, and other as choices that may be selected by the user. An additional transport group 430 includes taxi, airport shuttle, limousine service, train, and none as choices that may be selected by the user. Additional or fewer choices for either group are possible, and additional or fewer option groups may be presented for other controls. In some implementations, these choice groups may be considered activity indicators, and the system may create a task in response to a user selection of an option within the group.

An interface (not shown) associated with step four of the process may permit a user to attach documents to the travel plan. Examples of documents that may be attached may include, without limitation, documents pertaining to appointments, agendas, itineraries, proposals, schedules, objectives, to-do lists, working copies, assignments, projects, opportunities, travel bookings, transportation services, accommodation services, reward programs, etc. Web links, email messages, or meeting requests can also be attached, according to an implementation.

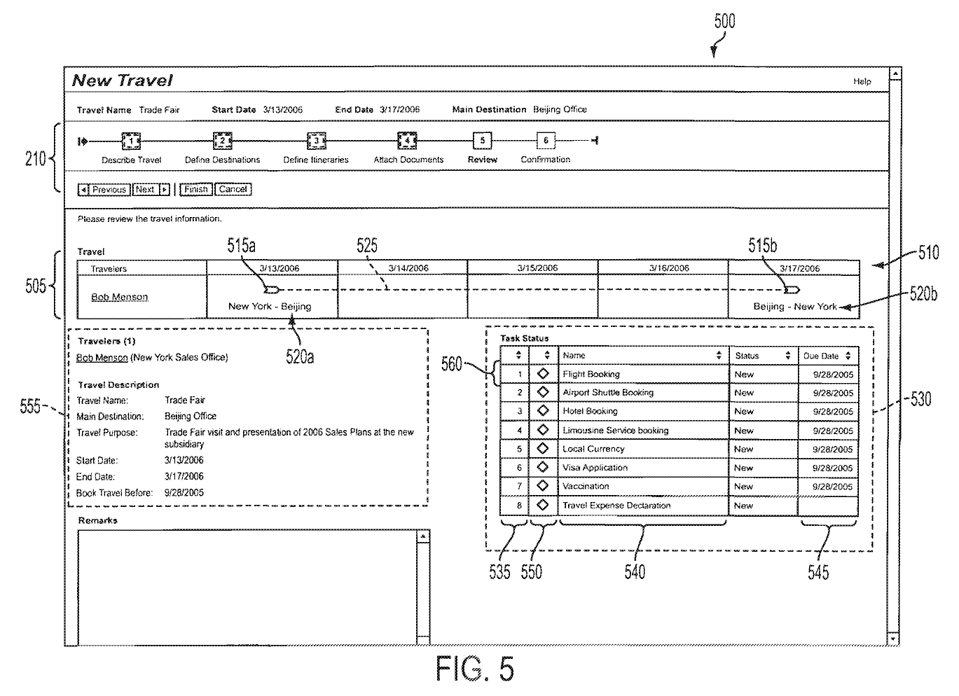

FIG. 5 is a screen shot of an exemplary user interface 500 that can be used for presenting tasks associated with a travel itinerary. The wizard area 210 shows that the program has progressed to step five of the process. A graphic area 505 includes a graphic 510 that may concisely describe the travel experience in a graphical manner, according to an implementation. In an implementation, the graphic 510 may include an icon 515 corresponding to each travel portion of the travel experience, and may include an accompanying description 520 of the travel portion. A first icon 515a indicates a first travel portion from New York to Beijing (520a) on Mar. 13, 2006, and a second icon 515b indicates a second travel portion from Beijing to New York (520b) on Mar. 17, 2006. The graphic 510 further includes a line 525 (a dashed line in this example) connecting the icons 515a, 515b, which may indicate that the traveler may remain in Beijing during the intervening days (3/14, 3/15, and 3/16) between the icons 515a, 515b. In this manner, the system may provide a graphical overview of the travel experience that a user may quickly view and understand, which may improve the user experience. In an implementation, the system may automatically create the graphic 510 based on entered information. For example, the system may use the entered destinations and dates to automatically create the graphic 510, as by creating an icon 515 for each main travel portion of the travel experience, creating a calendar view for the appropriate dates included in the travel experience, and including the appropriate icons 515 on departure dates of the calendar view. A description 520 corresponding to the origin and destination may be added for each icon 515, and one or more connecting lines 525 may connect the icons 515.

A task area 530 includes eight tasks in this example, one for each line of the task area 530. The tasks are numbered one through eight in a task number column 535 of the task area 530. Each task is described in a name column 540 of the task area 530. Tasks included in this example include “flight booking” 560, which may indicate that the user should book a flight; “airport shuttle booking,” which may indicate that the user should book an airport shuttle; “hotel booking,” which may indicate that the user should book a hotel room; “limousine service booking,” which may indicate that the user should book a limousine; “local currency,” which may indicate that currency should be exchanged; “visa application,” which may indicate that the traveler may need a visa for the travel; “vaccination,” which may indicate that the traveler should get a vaccination before the travel; and “travel expense declaration,” which may indicate that the user should submit an expense report (such as after the traveler has completed the travel). Some of the tasks (tasks 1-7 in this example) have a due date associated with the task in a due date column 545 of the task area 530. In an implementation, the tasks may include a status indicator, shown illustratively in the exemplary interface 500 in a status column 550 of the task area 530. The status indicator may indicate a level of completion for the task, such as complete, in process, or remaining to be completed. Indicator colors, such as green, orange, and red may be used to define the levels of completion, according to an implementation. In other implementations, a textual description of the status may be used.

In some implementations, a task may be selectable by the user. For example, the task may include a hyperlink that, when selected, causes the system to present further information pertaining to the task. Tasks may be selectable in a number of ways, depending upon the implementation. For example, the task name (shown in this example in the name column 540 for each task) may be a hyperlink, as described above. Alternatively, controls such as a button or selectable icon may be used for task selection. A given travel plan may have any number of tasks.

In an implementation, the system may create the tasks based on selected options or activity indicators. For example, referring again to FIG. 3, activity indicators corresponding to hotel, limousine service, local currency, visa, and vaccination are selected in the interface 300, and the system has created corresponding tasks in the task area 530 of the present interface 500.

There are many possibilities for tasks that may be created, including flight booking, hotel booking, rental car booking, and passport, to list just four examples. A passport task, for example, may indicate that a traveler should carry a passport on the travel, or that a passport should be renewed or applied for, for example. As described above, a task may remind the user or the traveler of an action to be performed in preparation for the travel by the traveler (e.g., visa or passport application or renewal), during the travel (e.g., local currency), or after the travel (e.g., travel expense declaration). Similarly, referring to FIG. 4, airport shuttle is selected as an additional means of transportation in interface 400, and a corresponding task appears in the task area 530. Thus, the system may automatically generate tasks based on received input, according to an implementation.

In an implementation, the system may generate a task despite not receiving input directly pertaining to the task. For example, in some implementations the system may generate a task for any travel experience satisfying a criteria. As an example, the system may create a travel expense declaration task for any travel where an expense report is expected. In some cases, the system may generate a task for every travel experience. A travel description area 555 summarizes details of the travel plan.

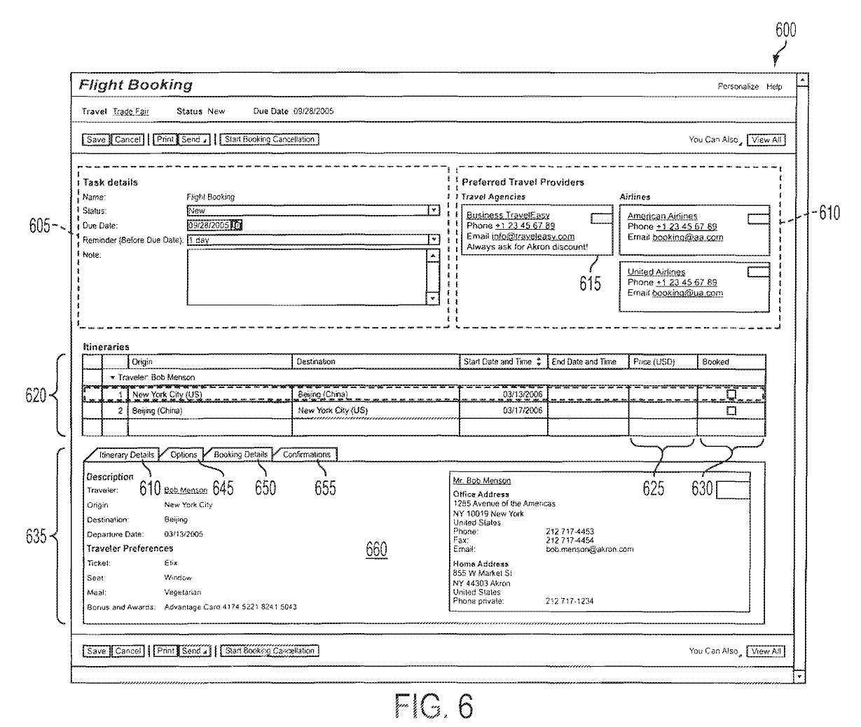

FIG. 6 is a screen shot of an exemplary user interface 600 that can be used for performing an action associated with a task. In an implementation, the system may present interface 600 when a user selects the flight booking task 560 in interface 500 (see FIG. 5). A task details area 605 provides the name of the task (Flight Booking) and high-level information pertaining to the task. A connection area 610 provides information and connections that the user can use to perform an action associated with the task. Since this is a flight booking task, the connection area includes information and links to travel providers and airlines. A user may select one of the links, as by clicking on the phone number, and the system may connect the user with the appropriate travel provider or airline in this example, using interface module 155, for example. For other tasks, other suitable information and links may be provided. In this example, the user might click on the phone number for the “Business Travel Easy” travel agency 615 and the system may connect the user to the agency so that the user may book a flight.

An itinerary view 620 shows details of the travel, here focusing on flight details. A price column 625 may permit the user to enter a cost for each flight, and a “booked” column 630 includes a checkbox that the user may check when a flight has been booked. In some implementations, the system may automatically include the price and an indication that a flight has been booked in the itinerary section 620. A composite area 635 includes tabs that may be selected to display content, including itinerary details 640, currently active in this example, options 645, booking details 650 and confirmations 655. As shown in interface 600, the itinerary details tab 640 includes a pane of information 660 that includes flight information and preferences. In general, a user may include preferences that a traveler may have that may apply to all similar tasks, such as preferences the traveler may have for all flights in this example. Pane 660 shows that the traveler prefers e-tickets, window seats, vegetarian meals, and lists the traveler's reward account number. The pane 660 also includes personal information on the traveler.

In various implementations, either the user or the system may use the preferences in performing the action associated with the task (booking a flight in this example). For example, for an assistant with travel responsibilities for several employees, the information in pane 660 may provide a helpful reminder of this traveler's preferences so that an appropriate flight may be booked. In other more-automated implementations, the system may use the information to automatically book a flight satisfying as many of the preferences as possible, or choosing a best available flight based on the listed preferences. The system or the user may search flights for the agencies or airlines listed in the connection area 610, for example. Thus, the interface 600 provides the information to make booking a flight easy, and may save the user time and may provide a convenient means to schedule travel and book a flight. The information may be provided in a single view, which may reduce the number of interface actions a user may need to perform, according to an implementation.

Using the options tab 645 of the composite area 635, a user may record booking options for each itinerary for future reference, according to an implementation. Final booking details, such as local start and end dates and times, final price, travel provider and the like may be entered using the booking details tab 650 of the composite area 635. The system may use data entered in various interfaces to update information in other interfaces, such as updating cost amounts or updating a task status, itinerary information, or the graphical representation of the travel experience.

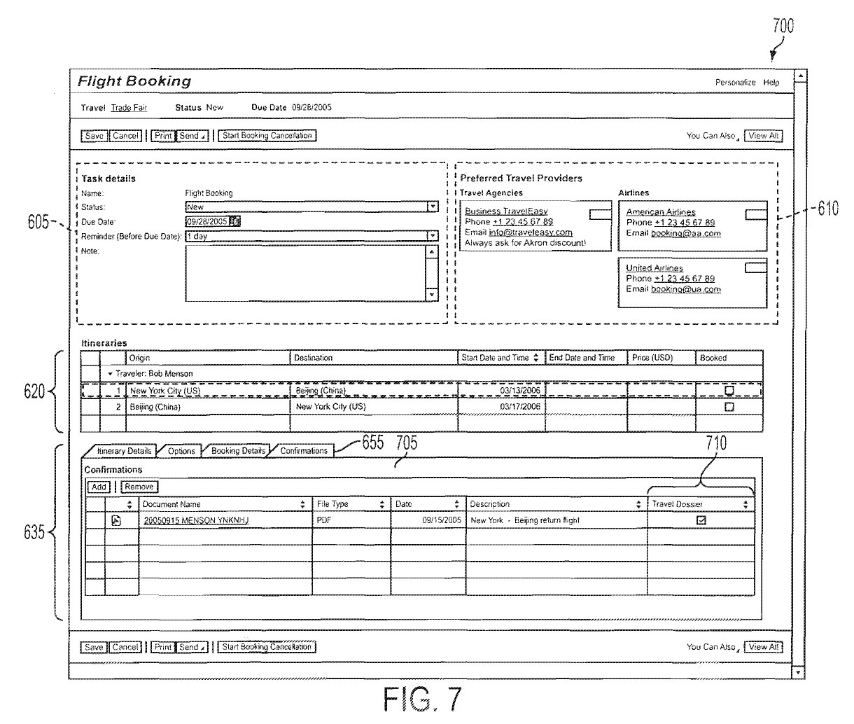

FIG. 7 is a screen shot of an exemplary user interface 700 that can be used for including task information with a travel itinerary. Interface 700 includes many of the same areas shown in interface 600 of FIG. 6. The confirmations tab 655 of the composite area 635 is active in interface 700. A pane 705 allows for the attachment of booking confirmations for each itinerary, according to an implementation. Files of various types may be attached, including word processing documents, HTML files, PDF files, or any other file type. A travel dossier column 710 includes a checkbox that when checked may indicate that the file or document should be printed and given to the traveler before the traveler departs, according to an implementation. In this example, a booking confirmation for a flight should be printed and delivered to the traveler. In various implementations, the system may automatically print the document or file, or the user may print the document or file. In some implementations, the document or file may be emailed to the traveler.

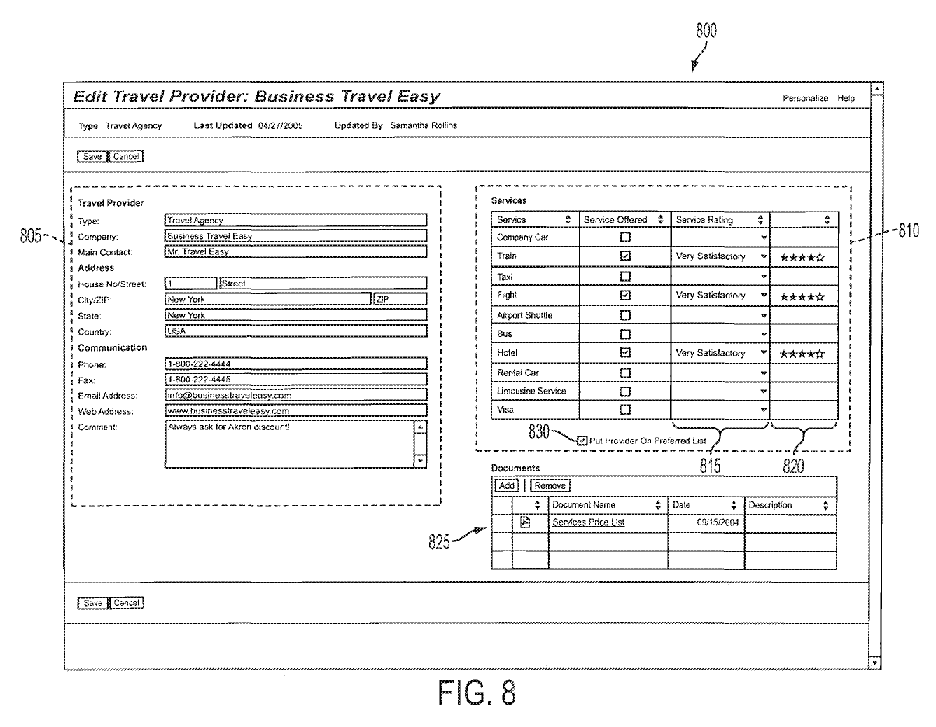

FIG. 8 is a screen shot of an exemplary user interface 800 that can be used for receiving travel-related feedback. In this example, a user may use interface 800 to enter feedback on the travel agency used to book the flights for the travel (see FIGS. 6-7). In other examples, feedback may be provided for any aspect of the travel experience, including transportation services (flight, taxi, train, bus, shuttle, etc.), accommodations (hotel, airport, etc.), preparation services (visa, passport, vaccination, etc.) and others (e.g., currency exchange, restaurants, tours, information on particular groups or individuals, etc.). An information area 805 includes fields that describe information for the entity for which feedback is to be provided.

A feedback area 810 permits the user or the traveler to enter ratings or feedback on the travel aspect. Ratings may be textual, such as the ratings provided in a service rating column 815 of the area 810. Ratings may also be pictorially represented, as by star ratings shown in column 820 of the area 810, for example. In this example, feedback has been entered for the flight, hotel, and for a train. The user may also indicate whether this aspect of the travel experience should be included on a preferred list. In this example, the user has checked a box 830 to indicate that the travel provider should be on the preferred list. In some implementations, the system may provide opportunities for feedback to be entered for each aspect of the travel experience related to a task, an itinerary, or both. The user may later refer to the feedback when selecting an aspect of travel for a future travel experience, for example. This may provide the user with helpful information so that future travel experiences may be improved. A documents area 825 may permit documents, such as a price list, to be attached for future reference.

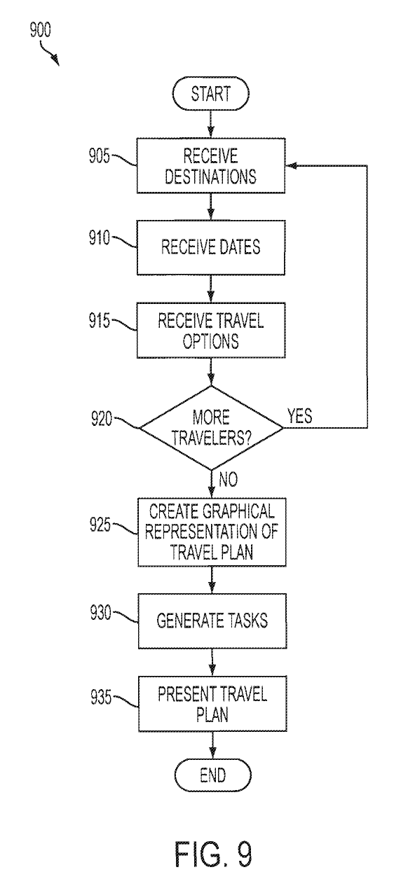

FIG. 9 is a flow chart 900 of exemplary operations that can be performed to create a travel plan. A process begins at step 905 with a receipt of one or more destinations for a travel experience. For example, referring again to FIG. 3, the system may receive a destination in area 305 or 310 of interface 300, as one example. As another example, the system may receive a destination in area 420 of interface 400 (see FIG. 4). At step 910, one or more dates may be received that correspond to the one or more destinations received at step 905. In an implementation, the dates may be departure dates for a traveler to the associated destination. Dates may be received in areas 310 or 420 in interfaces 300 and 400, respectively, for example.

Travel options, or activity indicators, may be received at step 915. In various implementations, activity indicators may describe traveler preferences, wishes, or activities for aspects of the travel experience. In an implementation, the activity indicator may indicate an activity for which an action should be taken or performed prior to the occurrence, use or enjoyment of the activity or of the travel experience. The activities may typically be associated with the travel experience or with a portion of the travel experience, according to some implementations. Activity indicators can relate to any aspect of the travel experience, including transportation options for the travel, accommodation options for the travel, appointment options for the travel, clearance or admissibility options for the travel, service options for the travel, communications or accessibility options for the travel, coordination details of the travel, and the like. Travel options may be associated with a destination, according to an implementation, or may be associated with the travel experience as a whole. Referring to FIGS. 3-4, activity indicators may be received in areas 315 and 420, according to an implementation. In an implementation, the input module 140 (FIG. 1) may receive the information at steps 905, 910 and 915.

If additional travelers have been indicated at step 920, the process returns to step 905 and continues as described above. A user may use area 215 and/or area 240 of interface 200 (FIG. 2) to indicate an additional traveler, as an example. If no additional travelers have been indicated at step 920, a graphical representation of the travel plan may be created at step 925. Graphic 510 in interface 500 (FIG. 5) is an example of a graphical representation of a travel plan. In creating the graphical representation, the system may create a contiguous succession of routes defined by the departure dates and destinations. For example, the system may arrange the departure dates in increasing calendar order, along with the corresponding destinations, and may create an icon for each destination (e.g., icons 515a and 515b). The system may then connect adjacent icons with a connecting line segment (e.g., line 525). In an implementation, the icon may be labeled with an origin and a destination of the route, such as labels 520 (FIG. 5). The itinerary generation module 145 (FIG. 1) may be used to create the graphical representation of the travel plan, according to an implementation.

At step 930, the system may generate one or more tasks for the travel plan. Task area 530 shows examples of eight tasks in interface 500 (FIG. 5). The task generation module 150 (FIG. 1) may be used to generate the one or more tasks for the travel plan, according to an implementation. Tasks may be generated based on predefined associations that the system has made between tasks and activity indicators. For example, the system may generate a task based on a received activity indicator, such as generating a “flight booking” task 560 after receiving a “flight” activity indicator (see area 420 in interface 400). At step 935, a travel plan is presented, and the process ends. The travel plan may be presented in a variety of ways, such as by displaying it on a display device, emailing it to an email account, storing it to a memory location, providing it as input to another application, printing, and the like. The presentation module 165 may be used to present the travel plan, which may include the one or more tasks generated in step 930 and the graphical representation of the travel plan generated in step 925. FIG. 5 shows an example interface 500 of a travel plan that includes tasks 530 and a graphical representation 510 of the travel plan.

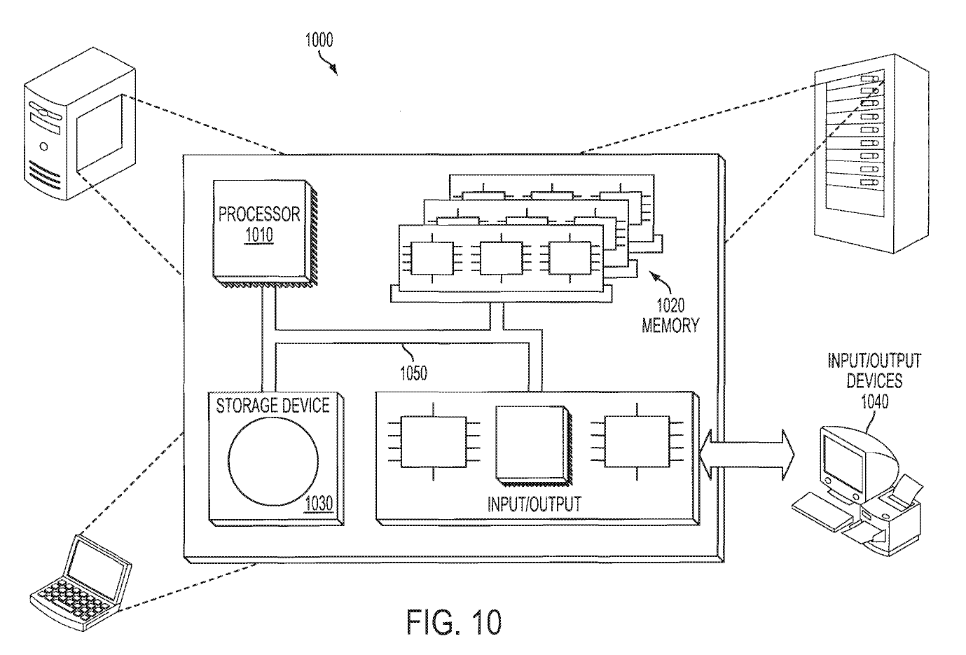

FIG. 10 is a schematic diagram of a computing system 1000 that can be used in connection with computer-implemented methods described in this document. The system 1000 can be used for the operations described in association with any of the computer-implement methods described previously, according to one implementation. The system 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the system 1000. In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the system 1000. In one implementation, the storage device 1030 is a computer-readable medium. In various different implementations, the storage device 1030 may be a floppy disk device, a hard disk device, an optical disk device, or a tape device.

The input/output device 1040 provides input/output operations for the system 1000. In one implementation, the input/output device 1040 includes a keyboard and/or pointing device. In another implementation, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and D)VD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of the methods, systems and apparatuses disclosed herein. Accordingly, other embodiments are within the scope of the following claims.

What is claimed is:

1. A computer-implemented method of creating a travel plan, the method comprising:
receiving from a user an identification of a traveler, a destination, a departure date, and one or more activity indicators;
generating one or more predefined tasks to be executed in preparation for travel by the traveler based on the received information, wherein each of the one or more received activity indicators is used to generate a task; and
displaying a travel plan that includes the one or more tasks to be executed.

2. The computer-implemented method of claim 1, wherein each of the one or more tasks includes a status indicator that describes a level of completion for the task.

3. The computer-implemented method of claim 1, wherein the one or more activity indicators are travel options.

4. The computer-implemented method of claim 1, wherein generating a predefined task comprises identifying a predefined task that is associated with the received activity indicator.

5. The computer-implemented method of claim 1, wherein each of the one or more tasks is associated with an action to be performed.

6. The computer-implemented method of claim 5, further comprising performing the action associated with the task.

7. The computer-implemented method of claim 1, wherein the one or more predefined tasks are selected from the group consisting of flight booking, hotel booking, rental car booking, and passport.

8. The computer-implemented method of claim 1, wherein the travel plan includes a graphical representation of the travel plan.

9. The computer-implemented method of claim 8, wherein the graphical representation of the travel plan includes an icon for each of one or more destinations in the travel plan, and one or more line segments that connect icons.

10. The computer-implemented method of claim 1, wherein each of the one or more received activity indicators is used to generate a distinct task.

11. The computer-implemented method of claim 1, further comprising exporting the one or more tasks to be executed to an external program application to be presented in the external program application.

12. A computer program product tangibly embodied in an information carrier and comprising instructions that when executed by a processor perform a method for creating a travel plan, the method comprising:
receive from a user an identification of a traveler, a destination, a departure date, and one or more activity indicators;
generate one or more predefined tasks to be executed in preparation for travel by the traveler based on the received information, wherein each of the one or more received activity indicators is used to generate a task; and
display a travel plan that includes the one or more tasks to be executed.

13. The computer program product of claim 12, wherein each of the one or more tasks includes a status indicator that describes a level of completion for the task.

14. The computer program product of claim 12, wherein the one or more activity indicators are travel options.

15. The computer program product of claim 12, wherein generating a predefined task comprises identifying a predefined task that is associated with the received activity indicator.

16. The computer program product of claim 12, wherein each of the one or more tasks is associated with an action to be performed.

17. The computer program product of claim 16, further comprising instructions that when executed perform the action associated with the task.

18. The computer program product of claim 12, wherein the one or more predefined tasks are selected from the group consisting of flight booking, hotel booking, rental car booking, and passport.

19. The computer program product of claim 12, wherein the travel plan includes a graphical representation of the travel plan.

20. The computer program product of claim 19, wherein the graphical representation of the travel plan includes an icon for each of one or more destinations in the travel plan, and one or more line segments that connect icons.

21. The computer program product of claim 12, wherein each of the one or more received activity indicators is used to generate a distinct task.

22. The computer program product of claim 12, further comprising instructions that when executed export the one or more tasks to be executed to an external program application to be presented in the external program application.

23. A computer-implemented method of creating a travel plan, the method comprising:
receiving from a user an identification of a traveler, a destination, a departure date, and one or more activity indicators;
generating one or more predefined tasks to be executed in preparation for travel by the traveler based on the received information, wherein each of the one or more received activity indicators is used to generate a task;
displaying a travel plan that includes the one or more tasks to be executed; and
connecting, in response to a user selection of one of the displayed tasks, to an external computing system to execute the task.
